(19) United States
(12) Patent Application Publication
(10) Pub. No.: US 2011/0178935 A1
(43) Pub. Date: Jul. 21, 2011

(54) Systems And Methods Of Integrated And Automated Generation Of Work Packages

(75) Inventors: Nikhil Chaubey, Simpsonville, SC (US); Austin Higgs, Greenville, SC (US); Richard Jerry Saine, Easley, SC (US)

(73) Assignee: FLUOR TECHNOLOGIES CORPORATION, Aliso Viejo, CA (US)

(21) Appl. No.: 13/120,091

(22) PCT Filed: Oct. 6, 2009
(86) PCT No.: PCT/US09/59705

§ 371 Date: Mar. 25, 2011

Related U.S. Application Data
(60) Provisional application No. 61/102,980, filed on Oct. 6, 2008.

(51) Int. Cl. G06Q 10/00

(52) U.S. Cl. 705/301

(57) ABSTRACT

Systems and methods of dynamic work package generation are presented that allow not only real-time modification of construction work packages, but also allow tracking of the work packages throughout completion and generation/updating of constructions records. The systems and methods contemplated herein will therefore improve management of safety and non-safety components, allow for traceability and tracking, and reduce errors due to user intervention.

This application claims priority to our provisional application with the Ser. No. 61/102,980, which was filed Oct. 6, 2008.

### FIELD OF THE INVENTION

The field of the invention is integration of automated work packages with various aspects of engineering and construction, especially as it relates to integration of such work packages with planning, tracking, validation, and/or archiving in highly complex construction environments.

### BACKGROUND OF THE INVENTION

As complexity and size of engineering projects increase, construction management has become increasingly important to control cost and man-hours. Moreover, where quality control records and certifications are required, or where traceability of work steps or workers are needed, demands on management are often substantial, particularly in the construction of nuclear facilities.

To assist in scheduling, material flow, and work progress monitoring, numerous methods and systems are known in the art. For example, U.S. Pat. App. No. 2005/0171790 describes a construction simulator in which work and material flow is simulated prior to implementation. Similarly, U.S. Pat. App. No. 2003/0033187 describes a construction management system in which the construction and its progress is graphically represented in a three-dimensional model to so help optimize work flow. In yet another known method, as taught in U.S. Pat. App. No. 2005/0065826, a work flow optimizer is presented in which bottlenecks are identified and recommendations for rectification are provided. Still further, RFID tagging of construction components to improve and track construction progress is described in WO 2004/008306.

While most of such known systems and methods provide at least some advantage in one or more areas of concern, various difficulties nevertheless remain. Among various other disadvantages, most known systems require significant user input for identification of code requirements. Still further, while overall construction progress, material flow, or scheduling of activities are simplified in some of the known systems, the currently known systems and methods are merely reactive to circumstances and fail to provide adaptive action with respect to history, record keeping, and/or anticipated activities. Thus, all or almost all of the known simulation programs require substantial user input where circumstances change and/or where validation or quality control is required. Viewed from a different perspective, work packages generated by heretofore known systems are generally static and often fail to provide dynamic feedback to the construction management to reflect actual progress, particularly with respect to compliance or non-compliance with code requirements.

Consequently, there is still a considerable need for improved systems and methods for generation of work packages that dynamically interact with the construction management in a simple and cost-effective simple manner, and that at the same time allow for archiving and report generation.

### SUMMARY OF THE INVENTION

The present inventive subject matter is drawn to systems, configurations, and methods of automated generation of work packages in which a plurality of objects and associated object attributes are automatically extracted from an engineering software into a component database that is functionally associated with a work package generator. The work package generator preferably allows real-time information to be transmitted to and/or received from various modules to modify the work package in real-time, and to automatically coordinate and manage new tasks as a function of changing information. Contemplated systems also allow for generation and/or updating of, inter alia, performance packages, control records, and/or construction records.

In one especially preferred aspect of the inventive subject matter, the inventors contemplate a method of dynamically generating a work package in which engineering software is executed on a construction server and in which a plurality of objects and associated object attributes are extracted from the engineering software into a component database, which is preferably functionally associated with a work package generator. Most typically, the work package generator is also functionally associated with various modules that interface with construction personnel and/or management to provide and/or request information relevant to the objects. Most preferably, at least some of the information includes standards or test requirements demanded by a particular construction code, and such information is automatically identified (i.e., requires no user intervention). For example, especially contemplated modules include performance modules, control modules, material manager modules, and/or certification modules. Information is then transferred from the performance module, the control module, the material manager module, and/or the certification module to the work package generator, wherein the information is used to generate or update the work package and/or a performance package, a control record, a material record, and/or a construction record.

In especially preferred aspects of the invention, the performance module is configured to generate a work package that is specific to a task associated with at least one of the objects and to receive and provide feedback to the work package generator. For example, the task may be welding and the feedback may be completion of a weld treatment that is mandated by a code requirement. To that end it is generally preferred that the performance module comprises a code-based rules set that is used to automatically determine the specific code requirements for the particular task. In other examples, the control module is configured to automatically determine a quality control request and/or a quality assurance request for at least one of the objects. In such case, the control module may be a quality control module that is preferably functionally associated with a quality control check list. In still further examples, the material manager module is configured to receive information for at least one of the plurality of objects without user intervention to so, for example, update the work package generator about delivery status of materials, quantity of remaining items on site, etc. Similarly, the certification module may be a craft certification module or a tool certification module, wherein the certification module is functionally associated with a craft certification list or a tool certification list.

In further contemplated aspects of the inventive subject matter, the work package generator may be configured such that a change in the performance module, the control module, the material manager module, and/or the certification module will result in an update or generation of the performance package, the control record, the material record, and/or the construction record. Most preferably, the step of using the information is performed in real-time, and/or the step of receiving information comprises a step of wireless transmission of the information or transmission via the Internet.

Therefore, in yet another preferred aspect of the inventive subject matter, a method of recording the status of an object in a construction project may include a step of executing an engineering software on a construction server and another step of extracting a plurality of objects and associated object attributes from the engineering software into a component database. In still another step, a work package is generated using a work package generator, wherein the work package includes at least one of the plurality of objects. In a further step, (preferably real-time) information is provided from a performance module, a control module, a material manager module, and/or a certification module to the work package generator, and the (real-time) information is associated with the status of the at least one of the plurality of objects. A performance package, a control record, and/or a construction record is then generated or updated based on the status.

In such methods, it is particularly preferred that the work package comprises a task for at least one of the objects and further comprises a code requirement associated with the task. Most typically, the work package generator is associated with a code-based rules set that is used to automatically determine the code requirement for the task. It is further generally preferred that contemplated methods include a step of feeding the (real-time) information to the performance module, the control module, the material manager module, and/or the certification module via transmission over the Internet or via wireless transmission. Particularly preferred status information include availability status of one or more of the objects, task progression status for one or more of the objects, task completion status for one or more of the objects, and/or quality control test results for one or more of the objects. Where desired, the step of generating or updating will include generating or updating at least two of the performance package, the control record, and the construction record based on the status.

Various objects, features, aspects and advantages of the present invention will become more apparent from the following detailed description of preferred embodiments of the invention.

### BRIEF DESCRIPTION OF THE DRAWING

FIG. 1 is a schematic depicting exemplary functional integration of a work package generator according to the inventive subject matter.

FIG. 2 is a schematic depicting a more detailed view of an exemplary integration of a work package generator according to the inventive subject matter.

FIG. 3 is a schematic depicting another view of a work package generator according to the inventive subject matter.

### DETAILED DESCRIPTION

The present inventive subject matter is drawn to systems, configurations, and methods of automated generation of work packages and associated documents, instructions, records, and/or requests, wherein the work package is dynamically tracked and/or interacts with other components throughout completion such that the work package/work package generator can function as feedback/record hub for the various other components (e.g., quality control, one or more other work packages, performance package, etc.).

It should be noted that while the following description is drawn to a computer/server based work package processing system, various alternative configurations are also deemed suitable and may employs various computing devices including servers, interfaces, systems, databases, or other types of computing devices operating individually or collectively. One should appreciate the computing devices comprise a processor configured to execute software instructions stored on a computer readable storage medium (e.g., hard drive, RAM, flash, ROM, etc.). The software instructions preferably configure the computing device to provide the roles, responsibilities, or other functionality as discussed below with respect to the specific apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

It should be appreciated that contemplated systems and methods are particularly advantageous for relatively complex engineering contracts, and especially for engineering in nuclear facilities where tractability for most of the work performed is required. As such requirements demand a significant amount of time to manage and track such work, heretofore known systems often failed to accurately and cost effectively plan, distribute, and manage construction work. Moreover, prior systems also often produced errors, which is especially undesirable where validation and tracking records are critical to safety.

Among other desirable characteristics, contemplated systems and methods will import relevant data from various systems (e.g., engineering design, procurement, project document and data management, etc.), manage and track each work package through construction, and later archive the work package or portions thereof as quality (or other) record. For example, contemplated systems and methods will allow and provide direct access to drawings and other documents (e.g., via functional association with project document and data management modules). The quality control and field staff can enter the information which will be stored electronically, and at the completion of the work package, at least part of the information will be archived.

Therefore, the inventors especially contemplate a method of dynamic work package generation in which in one step an engineering software is executed on a construction server and in which a plurality of objects and associated object attributes are automatically extracted from the engineering software into a component database. Most typically, the component database is functionally associates with a work package generator, that is in turn functionally associated with various other modules, and especially a performance module, a control module, a materials manager module, and a certification module. In another step, information is then transferred from one or more of the performance module, the control module, the material manager module, and the certification module to the work package generator, and the information is then used to generate and/or update a performance package, a control record, a material record, and/or a construction record.

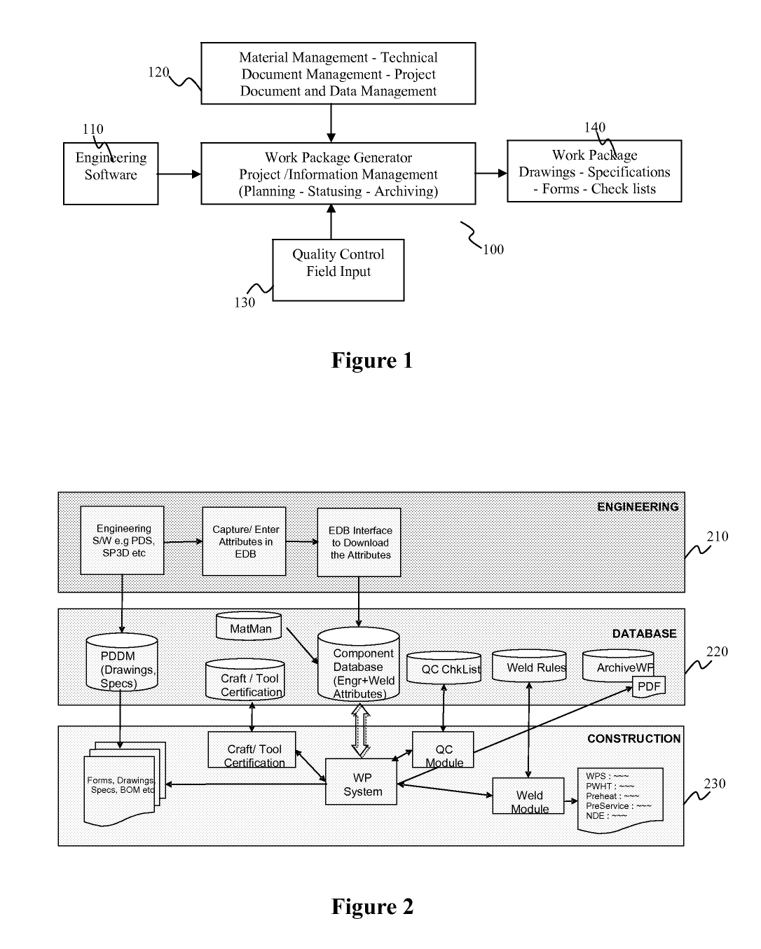

In particularly preferred aspects, the work package generator is integrated into a larger engineering computer system as exemplarily depicted in FIG. 1. Here, work packages 140 will be constructed by work package generator 100 from objects (e.g., weldments, reactors, etc.) that are provided by or extracted from the engineering software 110 (typically via a component database). Code requirements and other information specific to the objects are provided by various modules 120 that are associated with the work package generator (e.g., materials managing module will provide availability or delivery schedule for specific objects or components, or a rules module will determine and provide specific rules (typically code based) for the manufacture or treatment of objects), and/or field input from one or more operators (which may or may not be on-site) may be provided by one or more control modules 130.

Consequently, it should be appreciated that the work package will be based not only on real-time conditions and thus allow for highly effective materials and work flow, but it also allows for the generation of production records, drawings, specifications, check lists, quality control and quality assurance records, etc. As it is generally preferred that the work package generator is prepared in an electronic database format, the work package may also serve as a searchable and sortable record that allows rapid identification of objects and/or persons of interest.

FIG. 2 provides a more detailed view of one exemplary structure that conceptually illustrates the interconnectivity of the work package generator contemplated herein. Here, the three main components, engineering related component 210, database related component 220, and construction related component 230 are shown. The engineering related component 210 typically includes commercially available engineering software and further includes software that is configured to extract a plurality of objects and respective associated object attributes from the engineering software. Alternatively, the engineering software may also generate an output file that includes the plurality of objects and respective associated object attributes. Regardless of the manner of obtaining the objects and associated attributes, an interface is then used to transfer the extracted (or otherwise obtained information) to a component database. Most typically, extraction and transfer are performed without user intervention.

Associated with the components database and/or the work package generator is a materials manager module that provides, for example, material availability, shipping schedules, backlog information, etc. to the component database and/or work package generator. Preferred systems will have a repository of all engineering components (e.g., cables, cable trays, pipe spool, pumps, etc.) and their respective attributes (e.g., drawing identification, weight, size, safety class, etc). A planning module in or associated with the work package generator the will then select a set of components in the work package and assign the package to a crew. Most preferably, the work package is tracked throughout completion and can so act as feedback and/or record hub for quality control, archiving, generation of further work packages, etc.). Therefore, real-time and even prospective work packages can be established. Moreover, field staff (e.g., QA/QC staff) will be able to record and/or validate the information and approve electronically. Upon completion, these work packages will be archived as quality record.

To provide even more information relevant to the work package generation module, the work package generation module is functionally associated with one or more other modules that interface with construction personnel and/or management to provide and/or request information relevant to the objects. For example, one or more of a performance module, a control module, and a certification module may be associated with the work package generation module to so allow (preferably real-time) input of relevant information, which in turn may be used by the work package generation module to generate and/or modify a performance package, a control record, and a construction record. Most typically, performance modules will allow generation of specific work packages (e.g., weld work packages, etc.) as well as provide feedback from the requested performance (e.g., weld heat treatments, weld inspection records, etc.). It is further preferred that such additional modules will functionally cooperate with additional databases that maintain regulatory information to so automatically generate the performance package. Particular details of such automatic generation of specific work packages are described in our co-pending International patent application with the title “SYSTEMS AND METHODS FOR AUTOMATION OF CONSTRUCTION WORK PACKAGES”, filed on Oct. 6, 2009, which is incorporated by reference herein.

With respect to suitable engineering software in conjunction with the teachings presented herein, it should be appreciated that all known engineering programs are deemed suitable for use herein so long as such programs will allow characterization of a plurality of objects for which the work package is to be generated. Most typically, the objects will have one or more individual and distinct identifiers, and the objects will typically be associated with a plurality of attributes that further characterize the object. For example, where the object is a weld, the engineering software will typically identify the weld by the type of weld (e.g., butt weld, corner weld, T-weld, etc.), the types of materials joined (e.g., stainless steel, carbon steel, etc.), the operating conditions of the welded structure (e.g., high-temperature or high-pressure operation, hydrogen conduit), etc. Therefore, suitable engineering programs include, among other programs, AIM, PDS (Intergraph Corp.), SP3D (SmartPlant, Intergraph Corp.), INtools (Intergraph Corp.) etc.

Depending on the type of engineering software, it is noted that contemplated systems and methods may extract objects and object attributes from an output or export file, or directly from the program (memory or disk). Alternatively, and again depending on the type of engineering program, it is noted that the objects and object attributes may also be provided by the program as an object database that can be directly used in the work package generation module. Regardless of the manner of extracting and/or creating the engineering database, it is preferred that at least some of the objects and/or object attributes in the engineering database are then processed (e.g., in the same computer or other networked computer) using a code-based rules set to thereby identify a plurality of requirements for the object.

It should be noted that the code-based rules set will vary substantially depending on the particular field and associated rules. For example, where the work package module is employed for generation of weld work packages, the code based rules set will be based on ASME and/or AWS published rules. Other fields of endeavor may employ alternative rules sets based on, for example, rules published by ASTM International (ASTM), the International Electrotechnical Commission (IEC), the International Organization for Standardization (ISO), and the National Association of Corrosion Engineers (NACE). Most preferably, and regardless of the particular standard setting body, it is contemplated that the code based rules set is developed as a table- or list-representation of a plurality of conditions and associated output values where the conditions meet the description of the object attributes, and wherein the output values represent the plurality of requirements set by the standards.

The code-based rules set is preferably derived or created from a collection of industry standards, which is then translated into a matrix against which object attributes can be compared with. Moreover, the code based rule set will also provide the code requirements matched up against the object attributes. Viewed from another perspective, it should be appreciated that the code based rule set represents a deconvoluted form of code requirements in a format that allows direct (rather than conditional) association with corresponding object attributes. In this way, the need for manual input (and inevitable operator error) from construction plans into a code calculator or other tool is eliminated and the process of work package generation is vastly accelerated. Viewed from another perspective, by ‘flattening’ a relatively complex set of conditional code rule requirements into a matrix with individual non-conditional requirements, and by analyzing the object attributes against the individual non-conditional requirements using a true/false logic, code requirements can be easily identified in an automated manner that will not require data input by an operator and interpretation of conditional code rule requirements. Consequently, it should be appreciated that an output can be generated that is based on the code requirements and that does not require human intervention.

Similarly, control modules may be employed in conjunction with the work package generator to automatically generate quality control and/or quality assurance requests and records. As before, it is generally preferred that the control modules will cooperate with a database of requirements and rules to so allow for automatic generation of the control records. Further contemplated modules that functionally cooperate with the work package generation module include certification modules (that will once again preferably cooperate with a database of requirements and rules to so allow for automatic generation of the certification requests and records), accounting modules to track payments, expenses, payroll, etc. While it is generally preferred that modules that are functionally associated with the work package generation module will allow exchange of information in both directions, unidirectional flow of information is also contemplated. For example, a module may be employed to generate a construction record (e.g., to make drawings, specifications, forms, etc). Of course, it should be appreciated that the flow of information may be performed in numerous manners, including wireless, over a network (e.g., LAN, WAN, Internet, etc.).

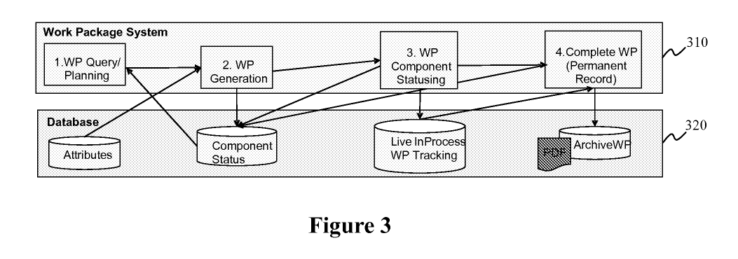

Therefore, a typical work package generator may be configured as exemplarily shown in FIG. 3, where the work package generator 310 is divided in distinct logical sections that follow the time line of construction, including work package query/planning, work package generation, component statusing, and perfection of the work package as a record. Of course, it should be appreciated that the work package generator need not be separated, but may be configured as a program that can execute all tasks as shown. Similarly, it should be noted that while the database 320 is shown as being divided in distinct logical sections, more or less sections may be actually present as FIG. 3 only schematically illustrates interconnectivity of various aspects. More specifically, it should be especially appreciated that all significant elements of the system are interconnected with at least one dynamic component (typically resident in a database) to so allow for real-time generation of work packages and records. As before, the dynamic component may be changed in an automated fashion (e.g., change in tracking or material availability via bar code scanning) or manual fashion (e.g., user input into database after quality control).

For example, the work package query and planning section of the work package generator will preferably be associated with a component status database that is dynamically updated to reflect (preferably in real time) the status, location, and availability of all objects in the construction site. Of course, it should be noted that the work package query and planning section is also associated with the engineering software (directly or indirectly, e.g., via component database) and a project data and document management database (not show) to generate one or more work packages. Most preferably, the work packages are built using object attributes that were previously extracted form the engineering software. As construction proceeds, feedback is provided to the work package generator from the construction personnel and/or management on progress and other construction related parameters (e.g., staffing for particular tasks, delays in performance, treatment or testing in progress or completed, quality control results, etc.) to so once again provide a dynamic change in the work package record. Upon completion of the work package, the work package generator provides one or more work package records that are then archived in any suitable format. Most preferably, the records are provided in electronic and searchable form.

Therefore, and viewed from a different perspective, the inventors also contemplate a method of recording status of an object in a construction project in which engineering software is executed on a construction server and in which a plurality of objects and associated object attributes are extracted from the engineering software into a component database. A work package is then generated with a work package generator, wherein the work package includes at least one of the plurality of objects. In another step, (preferably real-time) information is provided from a performance module, a control module, a material manager module, and/or a certification module to the work package generator, wherein the (real-time) information is associated with the status of the at least one of the plurality of objects. In yet another step, at least one of a performance package, a control record, and a construction record is generated or updated based on the status. As used herein, the term “real time” in conjunction with information refers to information that is reflective of an actual situation or change in situation where the change occurred less than 24 hours, and more typically less than 12 hours from entry or transmission of the information.

Consequently, it should be appreciated that contemplated systems and methods will allow automation of work package planning, generation, and tracking for the entire construction project to so significantly improve management of safety and non safety components as well as improve traceability and tracking of all components used in the project. Among other advantages, it should be recognized that automation allows for significant savings in construction. For example, where the system is used to automatically produce weld work packages, parameters such as welding procedure specifications (WPS), post weld heat treatment (PWHT), non-destructive examination (NDE), Pre Service, and Pre Heat treatments are not only automatically determined, but the work package generator will also provide the required documentation to meet the United States nuclear regulatory commission inspections, test, analyses, and acceptance criteria (NRC ITAAC) requirements for nuclear and non-nuclear work.

As contemplated systems involve multiple modules for work package generation and record production, work coordination by installation sequence is enabled. Moreover, such systems and methods allow for automated population of work packages with required engineering data, automated generation of welding WPS and associated requirements, NDE requirements, and quality control inspection, and still further allow for hardcopy and/or electronic copies of work packages. Thus, it should be appreciated that work available by area and type of work can be easily identified as can be work remaining by a turnover system. Viewed from a different perspective, contemplated methods and systems allow for generation of a to-be completed punch list for system turnover.

Thus, specific compositions and methods of automated generation of work packages have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Furthermore, where a definition or use of a term in a reference, which is incorporated by reference herein is inconsistent or contrary to the definition of that term provided herein, the definition of that term provided herein applies and the definition of that term in the reference does not apply.

What is claimed is:

1. A method of dynamic work package generation, comprising:
executing an engineering software on a construction server and extracting a plurality of objects and associated object attributes from the engineering software into a component database;
functionally associating the component database with a work package generator;
wherein the work package generator is functionally associated with a performance module, a control module, a materials manager module, and a certification module;
transferring information from at least one of the performance module, the control module, the material manager module, and the certification module to the work package generator; and
using the information to generate or update at least one of a performance package, a control record, a material record, and a construction record.

2. The method of claim 1 wherein the performance module is configured to generate a work package that is specific to a task associated with at least one of the plurality of objects and to receive and provide feedback to the work package generator.

3. The method of claim 2 wherein the task is welding and wherein the feedback is completion of a treatment mandated by a code requirement.

4. The method of claim 3 wherein the performance module comprises a code-based rules set that is used to automatically determine the code requirement for the task.

5. The method of claim 1 wherein the control module is configured to automatically determine at least one of a quality control request and a quality assurance request for at least one of the plurality of objects.

6. The method of claim 1 wherein the control module is a quality control module, and wherein the quality control module is functionally associated with a quality control check list.

7. The method of claim 1 wherein the material manager module is configured to receive information for at least one of the plurality of objects without user intervention.

8. The method of claim 1 wherein the certification module is a craft certification module or a tool certification module, and wherein the certification control module is functionally associated with a craft certification list or a tool certification list.

9. The method of claim 1 wherein the work package generator is configured such that a change in at least one of the performance module, the control module, the material manager module, and the certification module results in an update or generation of at least one of the performance package, the control record, the material record, and the construction record.

10. The method of claim 1 wherein the step of using the information is performed in real-time.

11. The method of claim 1 wherein the step of receiving information comprises a step of wireless transmission of the information or transmission via the Internet.

12. A method of recording status of an object in a construction project, comprising:
executing an engineering software on a construction server and extracting a plurality of objects and associated object attributes from the engineering software into a component database;
generating a work package using a work package generator, wherein the work package includes at least one of the plurality of objects;
providing real-time information from at least one of a performance module, a control module, a material manager module, and a certification module to the work package generator;
wherein the real-time information is associated with the status of the at least one of the plurality of objects; and
generating or updating at least one of a performance package, a control record, and a construction record based on the status.

13. The method of claim 12 wherein the work package comprises a task for the at least one of the plurality of objects and further comprises a code requirement associated with the task.

14. The method of claim 13 wherein the work package generator is associated with a code-based rules set that is used to automatically determine the code requirement for the task.

15. The method of claim 12 further comprising a step of feeding the real-time information to the at least one of the performance module, the control module, the material manager module, and the certification module via transmission over the Internet or via wireless transmission.

16. The method of claim 12 wherein the status is selected from the group consisting of an availability status of the at least one of the plurality of objects, a task progression status for the at least one of the plurality of objects, a task completion status for the at least one of the plurality of objects, and a quality control test result for the at least one of the plurality of objects.

17. The method of claim 12 wherein the step of generating or updating comprises generating or updating at least two of the performance package, the control record, and the construction record based on the status.
